(19) United States
(12) Patent Application Publication
(10) Pub. No.: US 2022/0232273 A1
(43) Pub. Date: Jul. 21, 2022

(54) REVENUE SHARING FOR ON-DEMAND MEDIA CONTENT CREATION AND SHARING

(71) Applicant: M35creations, LLC, Virginia Beach, VA (US)

(72) Inventor: Michael Joseph ERNEST, Virginia Beach, VA (US)

(21) Appl. No.: 17/150,857

(22) Filed: Jan. 15, 2021

(51) Int. Cl. H04N 21/2543; H04N 21/472; G06Q 40/00

(52) U.S. Cl. CPC H04N 21/2543; G06Q 40/12; H04N 21/47202

(57) ABSTRACT

This disclosure describes techniques for monetizing on-demand requests by a consumer of a hyper-specific media content in a network environment. Particularly, the monetizing of a requested hyper-specific media content utilizes a revenue-sharing scheme that outlines payment of compensation to parties based upon a consumption of the requested hyper-specific media content. The hyper-specific media content may include specified audio, video, etc. that relates to hyper-specific criteria (e.g., specific subject, location, and time condition). In an embodiment, the revenue-sharing scheme may include pre-configured or customizable attributes that outline the monetization of the hyper-specific media content.

### BACKGROUND

Traditionally, consumers have been forced to consume media content in a relatively structured manner. For example, before the advent of cable television, a consumer had relatively few choices in television programming. The consumer wishing to view a particular program had to determine on which station, and at which time the program would be aired.

Over the past few years, content options for consumers have grown dramatically due to the large number of client software applications that have been introduced in the market. There is an ever-increasing variety of content available to consumers via cable networks, satellite distribution, over-the-air broadcasts, the Internet, etc., including without limitation digital and analog video, audio, and multimedia content. Moreover, a variety of devices, such as wireless phones, handheld devices (including PDA, game consoles, etc.) provide more flexibility in the consumption of such content. Similarly, on-demand services and personal video recorders (“PVR”) have increased the flexibility for consuming such content. As a result, there is a trend toward consumers viewing and/or listening to entertainment content when and where they desire.

However, consumers are presently limited to accessing multi-media content that was created or authored and scheduled by third-parties rather than as specified by the consumers. Accordingly, present software applications are limited in enabling consumers to specify multi-media content to be created or authored on-demand.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a diagram of an example cellular network environment that facilitates a delivery of a hyper-specific media content from a content creator device to a requesting consumer device and/or other distribution platforms, in accordance with at least one embodiment.

FIG. 2 is a diagram of an example network server environment, in accordance with at least one embodiment.

FIG. 3 is a block diagram of an example look-up table (LUT) that may be used to implement a monetization of a requested hyper-specific media content, in accordance with at least one embodiment.

FIG. 4 is a flow diagram of an example methodological implementation for establishing a revenue-sharing scheme between a requestor and a content creator, in accordance with at least one embodiment.

FIG. 5 is a flow diagram of an example methodological implementation for filtering and implementing the revenue-sharing scheme between the requestor and the content creator, in accordance with at least one embodiment.

### DETAILED DESCRIPTION

This disclosure describes techniques for monetizing on-demand requests by a consumer of a hyper-specific media content in a network environment. Particularly, the disclosed monetizing of a requested hyper-specific media content utilizes a revenue-sharing scheme that outlines payment of compensation based upon consumption of the requested hyper-specific media content. The revenue-sharing scheme may be a compensation model that is configured to define payment of service fees to a content creator, sales percentage to a requestor, and other conditions that relate to the monetization of the hyper-specific media content. The hyper-specific media content may include specified audio, video, other media, or multi-media combination content that relates to hyper-specific criteria. The hyper-specific criteria cover a specifically requested subject and/or object at a specific location, for a specific time, and for a specific future context or event sufficient for a third-party to author media content to capture that context or event. Hyper-specific criteria support requests for hyper-specific media content that is unlikely to be generated let alone purposely available online. With the hyper-specific criteria in the media request, the consumer may now order exactly the content to be created or authored, to the point of being able to capture expected particular or future events, on-demand. Further, the consumer may now leverage the capturing of the exact content to obtain revenues from third parties who may consume the hyper-specific media content via different distribution platforms.

In an example network environment, a content crowdsourcing application (app) in a server may receive (from a consumer device) a consumer request with associated hyper-specific criteria. The content crowdsourcing app may compare the received hyper-specific criteria with stored hyper-specific criteria in a database and retrieves revenue-sharing schemes that are associated with matching stored hyper-specific criteria in the database. The stored hyper-specific criteria may include hyper-specific media contents that have been previously transmitted by content creator devices. In this regard, the revenue-sharing schemes and other data that may be associated with the matching hyper-specific criteria can also be applied as potential revenue-sharing schemes and reference data for the compared hyper-specific criteria in the consumer request. Each one of the revenue-sharing schemes includes attributes such as destination points for posting of the requested hyper-specific media content, amount of service fees to be paid to a content creator device, sales percentage that will be paid for the consumer device, cancellation policy, royalty fees, and other terms and conditions that may be agreed upon by the parties.

In one example, the consumer request may also include a specific revenue-sharing scheme attribute. In this regard, the content crowdsourcing app may utilize the user entered specific revenue-sharing scheme attribute to select or filter the retrieved revenue-sharing schemes that are associated with the matching stored hyper-specific criteria in the database. For example, the content crowdsourcing app receives the consumer request that includes the hyper-specific criteria and a specific revenue-sharing scheme attribute such as a particular destination point (e.g., YouTube™). In this example, upon retrieval of the revenue-sharing schemes that are associated with the matching stored hyper-specific criteria in the database, the content crowdsourcing app may further filter the retrieved revenue-sharing schemes by selecting only the revenue-sharing schemes that include YouTube™ as the destination point. In other cases, one or more specific attributes of the revenue-sharing schemes may be associated with the consumer request, and the content crowdsourcing app may utilize the one or more specific attributes to select the revenue-sharing schemes that are associated with the matching hyper-specific criteria in the database.

In an embodiment, the content crowdsourcing app may send the retrieved revenue-sharing schemes to the content creator devices; receive selected revenue-sharing schemes from responding content creator devices; transmit the received selected revenue-sharing scheme to the consumer device; and collect a confirmation of the revenue-sharing scheme to be used from the consumer device. The content crowdsourcing app may then facilitate the transmission of the hyper-specific media content to the consumer device and/or consumer desired destination points. In one example, the content crowdsourcing app may monitor revenue-sharing scheme attribute metrics or parameters that relate to the consumption of the hyper-specific media content at the destination points. The revenue-sharing scheme attribute metrics may include the number of views, number of purchases or downloads, number of media content sharing, and other measurements that relate, for example, to the consumption of the media content in the destination points that include distribution platforms. With the monitored revenue-sharing scheme attribute metrics or parameters, the content crowdsourcing app may implement the terms and conditions in the revenue-sharing scheme attributes and facilitate payments of service fees, sales percentage, etc. to the content creator devices and/or the consumer device.

In one example, the revenue-sharing schemes are stored in a look-up table (LUT) in the database. For each stored revenue-sharing scheme, the content crowdsourcing app may initialize different revenue-sharing scheme attributes and values of these attributes. The attributes may include revenue-sharing scheme features such as destination points, service fees, terms of payment, royalty fees, applied policy, triggering thresholds, etc. The values may include a particular condition, amount, or measurement of the attribute. In one example, the stored revenue-sharing scheme may include pre-configured values for the attributes. In other cases, the stored revenue-sharing scheme may be modified or customized based upon the agreement that may be entered into by the parties. For example, the consumer device proposes a certain amount of service charges, and the content creator counter-offers with a different amount. In this example, the content crowdsourcing app may adjust the revenue-sharing scheme based upon the amount of service charges that may be agreed upon by the parties.

The implementation and operations described above ascribed to the use of the server; however, alternative implementations may execute certain operations in conjunction with or wholly within a different element or component of the system(s). Further, the techniques described herein may be implemented in a number of contexts, and several example implementations and context are provided with reference to the following figures. The term “techniques,” as used herein, may refer to system(s), method(s), computer-readable instruction(s), module(s)m algorithms, hardware logic, and/or operation(s) as permitted by the context described above and throughout the document.

### Example Network Environment

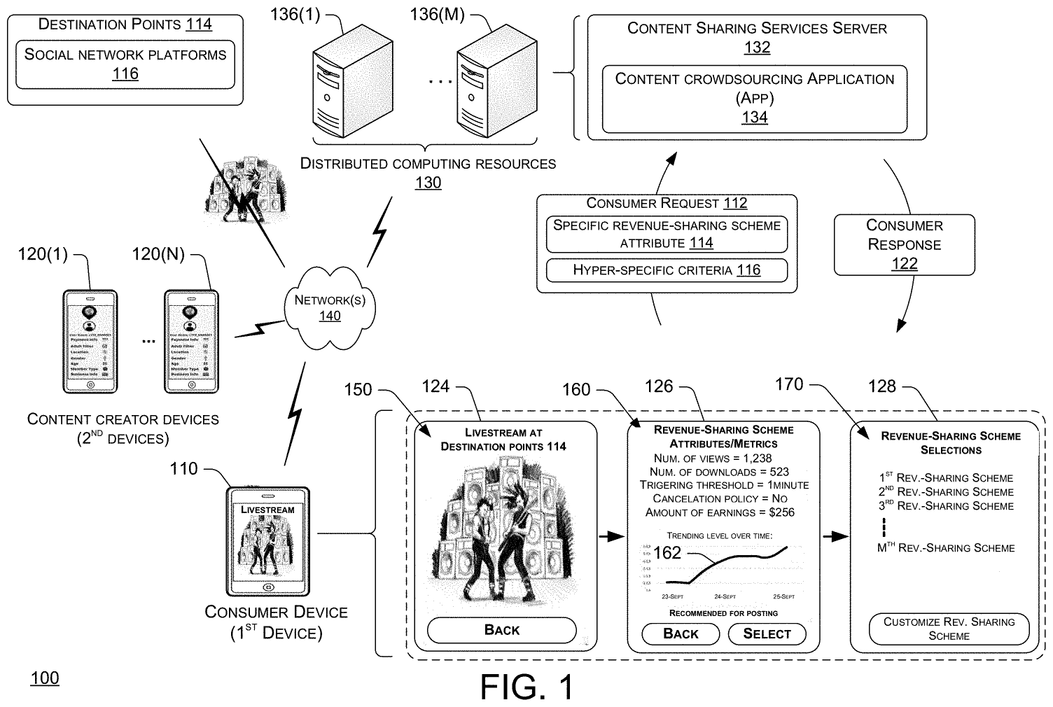

FIG. 1 illustrates a schematic view of a cellular network environment 100 that facilitates a delivery of a hyper-specific media content from a content creator device to a requesting consumer device and/or other distribution platforms. In one example, where consumers desire specific content, the consumers may associate hyper-specific criteria in a consumer request to define at least the specific subject, location, and time condition of the hyper-specific media content to be transmitted by the content creator device. In this regard, the consumers may be able to view on-demand the hyper-specific media content without relying on the probability that the hyper-specific media content is handily available through regular Internet searches.

Further, the consumers may leverage the capturing of the hyper-specific media content to obtain revenues from subscribers or third party viewers who may consume the hyper-specific media content via the distribution platforms. The monetization of the requested hyper-specific media content may utilize pre-configured and/or customizable revenue-sharing schemes that outline terms, conditions, and/or compensation of the parties to the consumption of the hyper-specific media content. Pre-configured revenue-sharing schemes include stored revenue-sharing schemes with pre-defined attributes and values while customizable revenue-sharing schemes may include the revenue-sharing schemes that are created using user-entered attributes and value preferences. In one example, a combination of pre-defined and customizable revenue-sharing schemes may be agreed upon by the parties.

The computing environment 100 includes a consumer device 110 that may communicate with destination points 114, content creator devices 120(1)-120(N), and distributed computing resources 130 via one or more networks 140. Destination points 114 may include distribution platforms such as social network platforms 116 that are in communication with other devices in the computing environment via the networks 140. For example, the social network platforms 116 include YouTube™, Facebook™, NFL channel, Netflix™, pay-per-view channel, and the like. In this example, the consumer device 110 may access the destination points 114 via application program interfaces (APIs) and the networks 140.

Distributed computing resources 130 may include one or more servers such as a content sharing services server 132. The content sharing services server 132 may further include a content crowdsourcing app 134 that implements the monetization of the requested hyper-specific media content. In one example, the content sharing services server 132 may receive a consumer request 112 including at least one specific revenue-sharing scheme attribute 114 and hyper-specific criteria 116 from the consumer device 110, and in doing so execute an algorithm that facilitates the sending of a consumer response 122. The consumer response 122 may include information related to back and forth communications with the consumer device 110. The at least one specific revenue-sharing scheme attribute 114 may include a requestor desired-attribute such as a particular destination point (e.g., YouTube™), amount of service fees, etc. in the revenue-sharing scheme to be used by the parties. The hyper-specific criteria 116 may include specific details and information about the requested media content such as, but not limited to, a specific object or subject, a particular location, particular context, a particular time window for capturing of the specific object, or subject, and the like.

The content sharing services server 132 may operate the distributed computing resources 130 that include one or more computing device(s) 136(1)-136(M). The distributed computing resources 130 may operate in a cluster or other configuration to share resources, balance load, increase performance, provide fail-over support or redundancy, or for other purposes. The one or more computing device(s) 136(1)-136(M) may include one or more interfaces to enable communications with other networked devices via one or more network(s) 140. The one or more network(s) 140 may include public networks such as the Internet, private networks such as an institutional and/or personal intranet, or some combination of private and public networks. The one or more network(s) 140 can also include any type of wired and/or wireless network, including but not limited to local area network (LANs), wide area networks (WANs), satellite networks, cable networks, Wi-Fi networks, Wi-Max networks, mobile communications networks (e.g., 3G, 4G, and so forth), or any combination thereof.

Each one of the consumer device 110 and content creator devices 120 may include an electronic communication device, including but not limited to, cellular phone, a smartphone, a session initiation protocol (SIP) phone, a laptop, a personal digital assistant (PDA), a satellite radio, a global positioning system (GPS), a multimedia device, a video device, a camera, a game console, a tablet, a smart device, a wearable device, or any other similar functioning device. The consumer device 110 may have a subscriber identity module (SIM), such as an eSIM, to identify the consumer device 110 to a telecommunication service provider network and/or the content crowdsourcing app 134.

As shown in FIG. 1, the consumer device 110 may display different information on its user interface. For example, in response to the received consumer request 112, the content crowdsourcing app 134 may send the consumer response 122 that includes a livestreaming of a hyper-specific media content 150 (e.g., live concert) at a first time instant 124. In this example, the consumer device 110 may distribute the hyper-specific media content 150 in the destination points 114 and in this regard, at second time instant 126, the content crowdsourcing app 134 may send revenue-sharing scheme attributes and measured metrics 160 as shown in the consumer device 110 user interface. The revenue-sharing scheme attributes and measured metrics 160 may include, for example, the number of views, number of downloads, purchases, and other metrics that relate to the consumption of the hyper-specific media content 150 in the destination points 114. Further, the revenue-sharing scheme attributes and measured metrics 160 may include terms and conditions that have been agreed upon by the parties.

In some cases, the content crowdsourcing app 134 may send to the consumer device 110 (at third time instant 128) other revenue-sharing scheme selections 170 that are stored in the database. The revenue-sharing scheme selections 170 may include different attributes and terms and conditions for the monetization of the requested hyper-specific media content 150. Subject to acceptance by the content creator devices 120, the consumer device 110 may select another form of compensation model in the revenue-sharing scheme selections 170.

The consumer device 110 may send the consumer request 112 including the hyper-specific criteria 116 to the content sharing services server 132 via a communication platform such as an audio-telecommunications service, an email service, short message service (SMS) platform, multimedia messaging (MMS) platform, a rich communication service (RCS) platform, or a social media messaging platform. With the received consumer request 112, the content crowdsourcing app 134 may compare the hyper-specific criteria 116 with stored hyper-specific criteria (not shown) in the database. The stored hyper-specific criteria may be associated with hyper-specific media contents that were previously transmitted by the content creator devices 120. The stored hyper-specific criteria may be associated also with the revenue-sharing schemes that were used in the previously transmitted hyper-specific media contents. Upon finding a match, the content crowdsourcing app 134 may utilize the associated revenue-sharing schemes features as a reference for the hyper-specific criteria 116 in the consumer request 112.

For example, upon finding of the matching hyper-specific criteria in the database, the content crowdsourcing app 134 sends the associated revenue-sharing schemes to the content creator devices 120. The content creator devices 120 selects from the received revenue-sharing schemes and send this information back to the content crowdsourcing app 134. Thereafter, the content crowdsourcing app 134 forwards the selected revenue-sharing schemes to the consumer device 110 for confirmation. This negotiation stage may include back and forth communications between the consumer device 110 and the content creator devices 120. With a selected revenue-sharing scheme, the content crowdsourcing app 134 may then implement the selected revenue-sharing scheme in the cellular network environment 100.

### Example Network Server Environment

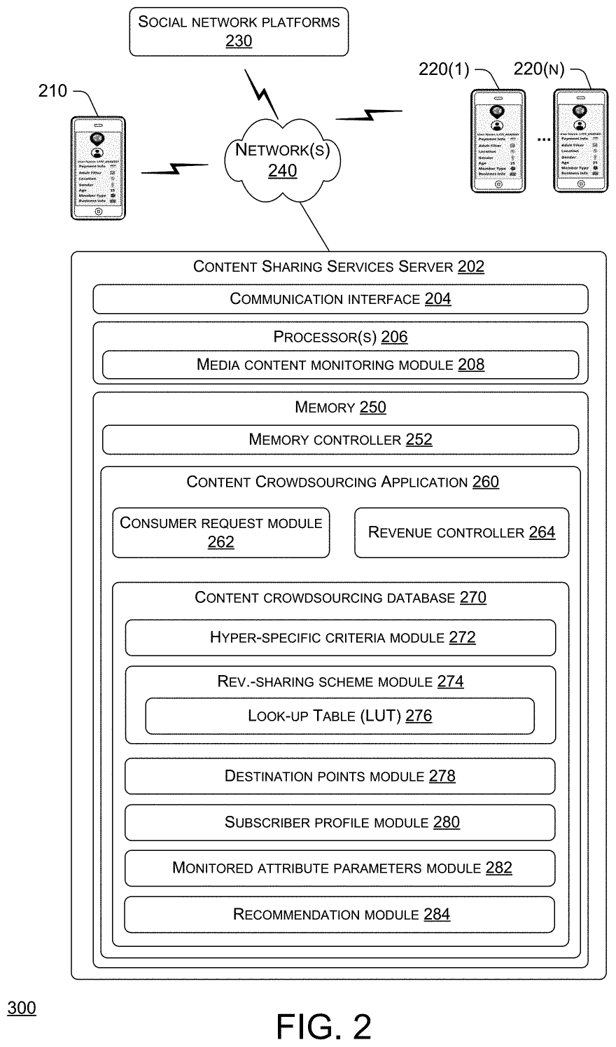

FIG. 2 is a diagram of an example network server environment 200, in accordance with at least one embodiment. The network server environment 200 includes a server such as a content sharing services server 202 that services an on-demand request by a consumer device 210 to view a hyper-specific media content that may be captured by content creator devices 220. The content sharing services server 202 may further implement a revenue-sharing scheme for monetization of the consumption of the requested hyper-specific media content at social network platforms 230. The social network platforms 230 may receive transmission of the requested hyper-specific media content from the consumer device 210 or content creator devices 220 via networks 240. The one or more content sharing services servers 132 shown in FIG. 1 are examples of the content sharing services server 202 in an extended operating environment, in particular, a cellular network environment 100.

The content sharing services server 202 includes hardware, software, or a combination thereof, that processes a consumer request including the hyper-specific criteria and sends a consumer response in return (e.g., consumer request 112/consumer response 122 in FIG. 1). The content sharing services server 202 includes a communications interface 204 that facilitates communication with devices, servers, financial services or institutions, social networking platforms, etc. that are located outside of the content sharing services server 202 and further provides networking capabilities for the content sharing services server 202. For example, the content sharing services server 202, by way of the communications interface 204, may exchange data with other electronic devices such as the consumer devices 210, content creator devices 220, bank servers, other laptops, computers, servers, etc. via the one or more networks 240. Communication between the content sharing services server 202 and other electronic devices may utilize any sort of communication protocol known in the art for sending and receiving data and/or voice communications.

The content sharing services server 202 includes a processor 206 having electronic circuitry that executes instruction code segments by performing basic arithmetic, logical, control, memory, and input/output (I/O) operations specified by the instruction code. The processor 206 can be a product that is commercially available through companies such as Intel® or AMD®, or it can be one that is customized to work with and control a particular system. The processor 206 may include a media content monitoring module 208 configured to monitor details of transactions for each one of the hyper-specific media contents as described herein. In one example, the details include the number of views, retransmissions, purchases, uploads, and the like, by the subscribers or third party viewers in the social network platforms 230. Further, the processor 206 may be coupled to other hardware components used to carry out device operations. The other hardware components may include one or more user interface hardware components not shown individually—such as a keyboard, a mouse, a display, a microphone, a camera, and/or the like—that support user interaction with the content sharing services server 202.

The content sharing services server 202 also includes memory 250 that stores data, executable instructions, modules, components, data structures, etc. The memory 250 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc—Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms.

A memory controller 252 is stored in the memory 250 of the content sharing services server 202. The memory controller 252 may include hardware, software, or a combination thereof, that enables the memory 250 to interact with the communication interface 204, processor 206, and other components of the content sharing services server 202. For example, the memory controller 252 receives the consumer request from the communication interface 204 and sends the received consumer request to a content crowdsourcing app 260 for further processing. In another example, the memory controller 252 may retrieve data from memory 250 where the data will be processed in the processor 206. Still, in another example, the memory controller 252 in communication with the processor 206 and the communication interface 204 may facilitate the sending of the consumer request to the content creator devices 220, and so on. The content crowdsourcing app 260 is similar to the content crowdsourcing app 134 in FIG. 1.

The memory 250 also stores the content crowdsourcing app 260 that, when executed, receives the hyper-specific criteria and at least one specific revenue-sharing scheme attribute in the consumer request, compares the hyper-specific criteria with stored hyper-specific criteria that are associated with previously transmitted hyper-specific media contents, retrieves a plurality of revenue-sharing schemes that are associated with matching hyper-specific criteria, filters or selects the plurality of revenue-sharing schemes based upon the received at least one specific revenue-sharing scheme attribute, and sends filtered revenue-sharing schemes to the content creator devices 220. The content crowdsourcing app 260 further receives content creator selected revenue-sharing schemes from responding content creator devices 220, collects consumer device's acceptance of at least one selected revenue-sharing scheme, and implements the selected revenue-sharing scheme that is agreed upon by the parties for the monetization of the requested hyper-specific media content.

In one example, the matching stored hyper-specific criteria may include similar specific object, location, and time as that of the hyper-specific criteria in the consumer request. In this regard, the plurality of revenue-sharing schemes that may be associated with the matching stored hyper-specific criteria can be assumed to be associated with the hyper-specific criteria in the consumer request. Further, the feature parameters and other data that may be associated with the matching stored hyper-specific criteria may also be assumed to be associated with the hyper-specific criteria in the consumer request.

The content crowdsourcing app 260 may be a single block of executable instructions or it may be made up of several components, as shown. The components included in at least one implementation are described below. However, it is noted that in other implementations, more or fewer components may be configured and that one or more operations attributed to a particular component in the following description may be implemented in one or more other components.

As shown, the content crowdsourcing app 260 includes a consumer request module 262, a revenue controller 264, and a content crowdsourcing database 270 including a hyper-specific criteria module 272, a revenue-sharing scheme module 274 with a look-up table (LUT) 276, a destination points module 278, a subscriber profile module 280, a monitored attribute parameters module 282, and a recommendation module 284. Although shown as part of the content crowdsourcing app 260, one or more components of the content crowdsourcing app 260 may be stored in other memory (not shown), in other content sharing services servers, or in remote locations. Further, each component of the content crowdsourcing app 260 can be realized in hardware, software, or a combination thereof. For example, the revenue-sharing scheme module 274 is a software module designed to perform specific processes as described herein.

The consumer request module 262 may be configured to receive and process a plurality of consumer requests (e.g., consumer request 112 in FIG. 1) from consumer devices. The consumer request includes, for example, the hyper-specific criteria that may define the specifications of the hyper-specific media content to be viewed by the consumer. The consumer request may further include a specific revenue-sharing scheme attribute such as destination points (e.g., social network platforms 230) that indicate where the consumer device is planning to distribute the requested hyper-specific media content. In this example, the consumer request module 262 may extract the components of the hyper-specific criteria that will be used as references for finding the matching stored hyper-specific criteria in the database.

For example, the received consumer request includes audio data, text data, image data, a pin drop, etc. that may represent the hyper-specific criteria for the requested hyper-specific media content. In this example, the consumer request module 262 may parse and extract the audio data and text data of the request via natural language processing (NLP) and natural language understanding (NLU) algorithms to determine a literal and intended meaning of the audio/text data in the consumer request. Further, the consumer request module 262 may extract the image data of the consumer request by extracting feature representations of the image data and determining similarities with a dataset of stored images within the content crowdsourcing database 270. The consumer request module 262 may then use a probabilistic machine learning algorithm (not shown) in order to identify the specific object in the consumer request. The consumer request module 262 may also parse the pin drop by utilizing the content crowdsourcing database 270 to search for the associated specific subject and location, and so on. After extracting the components, the consumer request module 262 may send the extracted components (e.g., specific subject, location, and like) to the revenue controller 264 for further processing.

The revenue controller 264 may be configured to identify content creator devices 220 that may capture the hyper-specific media content, sends one or more revenue-sharing schemes to identified content creator devices 220, communicate to the consumer device 210 at least one revenue-sharing scheme that is received from responding content creator devices 220, and implement the revenue-sharing scheme that will be agreed upon by the parties.

For example, the revenue controller 264 compares the identified/extracted components of the hyper-specific criteria in the consumer request with a list of stored hyper-specific criteria 272 in the content crowdsourcing database 270. Given a situation where the matching hyper-specific criteria are found, the revenue controller 264 may identify the content creator devices 220 that are associated with the matching hyper-specific criteria. These associated content creator devices 220 may be considered as potential content creator devices that may transmit the requested hyper-specific media content. Further, the revenue controller 264 identifies at least one revenue-sharing scheme in the LUT 276 that is associated with the matching hyper-specific criteria. The revenue controller 264 may then facilitate the sending of the identified at least one revenue-sharing scheme to the potential content creator devices 220. In some cases, the revenue controller 264 may filter the revenue-sharing schemes to be communicated to the potential content creator devices 220 based upon the specific revenue-sharing scheme attribute in the consumer request.

Given a situation where no matching hyper-specific criteria are found in the hyper-specific criteria module 272, the revenue controller 264 may create and save the extracted components as new hyper-specific criteria in the hyper-specific criteria module 272. The revenue controller 264 can associate the new hyper-specific criteria with a customer's profile in the subscriber profile module 278. Further, the revenue controller 264 may associate at least one revenue-sharing scheme in the LUT 276 with the newly created hyper-specific criteria. The associated revenue-sharing scheme may include the specific revenue-sharing scheme attribute in the consumer request.

The content crowdsourcing database 270 may be configured to store data that will be used to implement the monetization of the requested hyper-specific media content. For example, the content crowdsourcing database 270 may store the revenue-sharing schemes that can be applied to the hyper-specific criteria in the consumer request. In another example, the content crowdsourcing database 270 may store the client profiles of the requestor, content creators, and so on.

The revenue-sharing scheme module 274 may be configured to create revenue-sharing schemes based upon the hyper-specific criteria, destination points, service fees, and other attributes that relate to the monetization of the requested hyper-specific media content. The created revenue-sharing schemes may be further based upon terms and conditions that may be agreed upon by the parties, existing policy (not shown), and other events that relate to the payment of revenues to the content creator device 220 and the consumer device 210. In one example, the revenue-sharing scheme module 274 may use the LUT 276 that includes a collection of pre-configured revenue-sharing schemes that can be associated with the stored hyper-specific criteria in the hyper-specific criteria module 272. The revenue-sharing scheme module 274 may configure the revenue-sharing schemes in the LUT 276 to be adjusted accordingly depending upon the applied policy and the terms and conditions agreed upon by the parties. For example, a non-payment of service fees that is due to the content creator device 220 may generate a corresponding adjustment in the compensation to be paid to the consumer device 210, and so on.

In one example, a pre-configured revenue-sharing scheme in the LUT 276 may include attributes such as the destination points for the requested media content, amount of initial service fees and percentage of sales amount that are due to transmitting content creator device, percentage of sales amount that are due to the consumer device that distributed the media content to the destination points, waiting time or a triggering condition for calculation of the service fees and the percentage of sales, form of payments, applied policy or terms and conditions, and other attributes that relate to the monetization of the consumption of the requested media content. Given a situation where at least one revenue-sharing scheme attribute is included in the consumer request, then the revenue controller 264 may use the at least one revenue-sharing scheme attribute to select the revenue-sharing schemes that will be communicated to the potential content creator devices 220.

Destination points module 278 may store IP addresses of different social networking platforms, distribution platforms, and other channels that facilitate access to and consumption of the requested hyper-specific media content. The destination points module 278 may further store device identifiers of subscriber devices that may be used as distribution points for the requested hyper-specific media content. In an implementation, the revenue controller 264 may use the destination points 278 as a revenue-sharing scheme attribute for selecting the revenue-sharing schemes that will be communicated to the potential content creator devices 220.

For example, a set of ten pre-configured revenue-sharing schemes are associated with the matching stored hyper-specific criteria in the hyper-specific criteria module 272. Each one of the ten pre-configured revenue-sharing schemes may include different destination point-attributes such as YouTube™, Netflix™, or other social network platforms. Given a situation where a specific destination point is also included in the consumer request, then the revenue controller 264 may use the particularly requested destination point-attribute to further filter the ten pre-configured revenue-sharing schemes that will be communicated to the potential content creator devices 220. In another example, the revenue controller 264 may use the client profile-attribute in the subscriber profile module 278 to further filter the ten pre-configured revenue-sharing schemes, and so on.

Subscriber profile module 280 may store information such as client profiles of requestors, content creators/authors, and other subscribers who may consume the requested hyper-specific media content via the networks 240. In one example, the subscriber profile module 280 stores the financial payment points such as credit card information that is associated with the customer device 210 and content creator devices 220, user ratings of the requestors and content creators, credit history, performance tracking, and other data that relate to the description of the devices, audience, and requestors.

The monitored attribute parameters module 282 may include historical usage, behavioral data, and other measured parameters that relate to the consumption of the hyper-specific media content. For example, the requested hyper-specific media content is distributed via the social network platforms 230. In this example, the monitored attribute parameters module 282 may include the detected number of downloads, view, shares, etc.

Recommendation module 284 may include an indication of a level of interest by third parties over the requested hyper-specific media content that is distributed via the networks 240. In one example, the revenue controller 264 may apply an algorithm to monitored feature parameters to classify the hyper-specific media content. The monitored feature parameters may include the detected number of comments, likes, shares, and other user-generated content in the social network platforms 230. In this case, the classification may include a new class or category for the hyper-specific media content. The class or category, for example, may indicate the level of interest by third parties to view, purchase, download, retransmit, etc. the hyper-specific media content.

Further functionalities of the content sharing services server 202 and its component features are described in greater detail, below, with respect to examples of methodological implementations of the novel techniques described and claimed herein.

### Example Look-up Table (LUT)

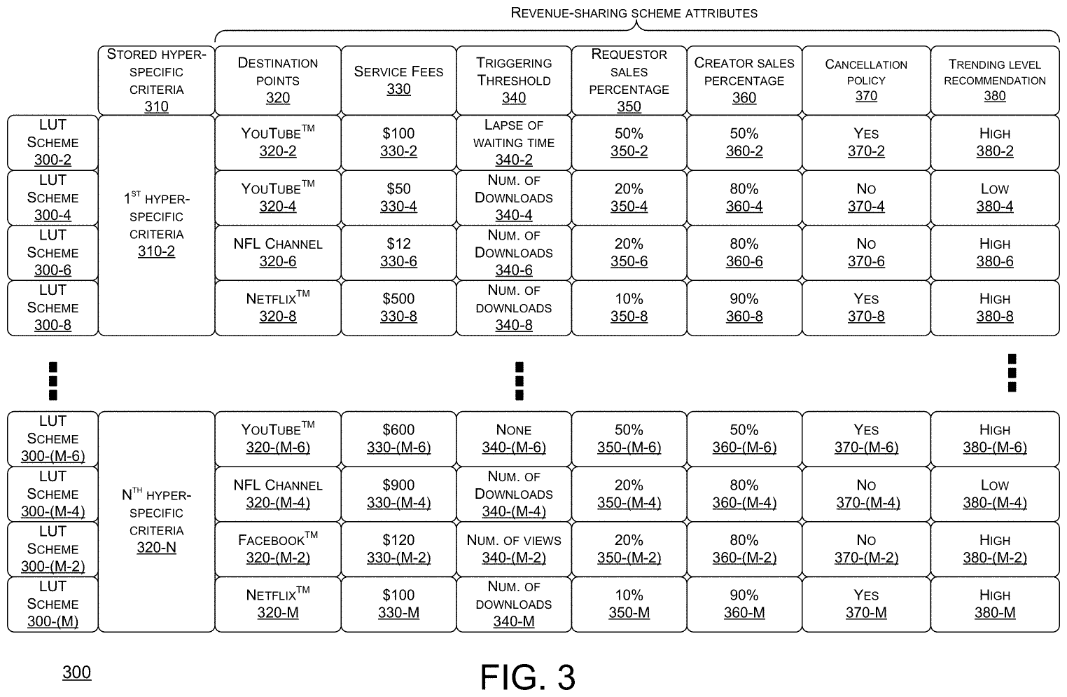

FIG. 3 is a block diagram of an example LUT 300 that may be used to implement the monetization of the requested hyper-specific media content, in accordance with at least one embodiment. The LUT 300 may include a selection of revenue-sharing schemes and corresponding revenue-sharing scheme attributes that outline a compensation for a consumption of the hyper-specific media content in the network environment such as the cellular network environment 100. The LUT 300 is similar to the LUT 276 in FIG. 2.

LUT 300 includes a plurality of revenue-sharing schemes 300(2)-300(M). Each one of the revenue-sharing schemes 300(2)-300(M) may be associated with a stored hyper-specific criteria 310 and revenue-sharing scheme attributes such as destination points 320, service fees 330, triggering thresholds 340, requestor sales percentage 350, creator sales percentage 360, cancellation policy 370, and trending level recommendation 380. In one example, multiple revenue-sharing schemes 310 and revenue-sharing scheme attributes may be associated with a single entry of stored hyper-specific criteria 310. In this case, the revenue controller 264 may use the specific revenue-sharing scheme attribute in the consumer request to further classify the revenue-sharing scheme 300 that may be selected by the parties.

The destination points 320 may include a specific revenue-sharing scheme attribute that identifies the distribution points for the requested hyper-specific media content. The distribution points may include social networking platforms or similar access points. For example, the destination points 320 for the revenue-sharing schemes 300(2)-300(8) include YouTube™ 320-2, YouTube™ 320-4, NFL channel 320-6, and Netflix™ 320-8, respectively. In this example, the hyper-specific media content may be consumed in a particular destination point that may be requested in the consumer request.

The service fees 330 may include a specific revenue-sharing scheme attribute that identifies the amount of service fees to be charged from a consumer device's account. In one example, the payment of service fees 330, requestor sales percentage 350, and creator sales percentage 360 may be conditioned upon a satisfaction of the corresponding triggering threshold 340. For example, when the requested hyper-specific media content is to be distributed via the YouTube™ 320-2, the revenue controller 264 may charge the service fees 330-2 ($100) upon the lapse of waiting time period 340-2, which corresponds to the destination point—YouTube™ 320-2. The waiting time period may be counted, for example, from a detection of a delivery timestamp of the downloaded hyper-specific media content in the YouTube™ 320-2 (destination point). In another example, when the requested hyper-specific media content is livestreamed via the NFL channel 320-6, the revenue controller 264 may charge the service fees 330-6 ($12) when a certain number of downloads 340-6 is reached. In this case, a minimum download threshold (e.g., 20 downloads) may be preconfigured as the triggering threshold 340 for destination point—NFL channel 320-6, and so on.

The triggering threshold 340 may include a specific revenue-sharing scheme attribute that identifies an initiation point for the calculation of the service fees 330, requestor sales percentage 350, and creator sales percentage 370. The triggering threshold 340 may further identify the time period when the cancellation policy 370 may be applied. Other terms and conditions (not shown) may be based upon the triggering threshold 340.

The cancellation policy 370 may include a specific revenue-sharing scheme attribute that is based upon terms and conditions that were agreed upon by the parties. For example, the terms and conditions may include possible cancellation (e.g., “Yes” 370-2) or non-cancellation (e.g., “No” 370-4) of the transaction. Other terms and conditions may be added for the stored hyper-specific criteria 310 without affecting the embodiments described herein.

In one example, upon receiving of the hyper-specific criteria in the consumer request, the revenue controller 264 may first search for the matching hyper-specific criteria in the hyper-specific criteria module 272. Upon finding of the matching hyper-specific criteria, the revenue controller 264 may use the LUT 300 to retrieve the plurality of revenue-sharing schemes that are associated with the matching hyper-specific criteria. Since the matching hyper-specific criteria are associated with multiple revenue-sharing scheme attributes, the revenue controller 264 may also use at least one specific revenue-sharing scheme attribute in the consumer request to further filter or select the revenue-sharing schemes to be sent to the content creator devices.

Given a situation where no matching hyper-specific criteria are found for the hyper-specific criteria in the consumer request, the revenue controller 264 may save the extracted components as new hyper-specific criteria (not shown) in the stored hyper-specific criteria 310. The revenue controller may also associate revenue-sharing scheme attributes and pre-configured revenue-sharing scheme attribute values for the service fees 330, triggering thresholds 340, requestor sales percentage 350, and creator sales percentage 360 for the new hyper-specific criteria. The user-requestor may further enter additional attribute or initialization data that can be associated with the new hyper-specific criteria.

The number of revenue-sharing scheme attributes in the LUT 300 are shown for illustration purposes and additional revenue-sharing scheme attributes may be used without affecting the embodiments described herein. For example, the revenue-sharing scheme attributes may further include sharing percentages on advertisement income, sharing of insurance fees, sharing of losses, optional revenue-sharing schemes to be used, etc.

### Example Implementation—Establishing Revenue Sharing Between Parties

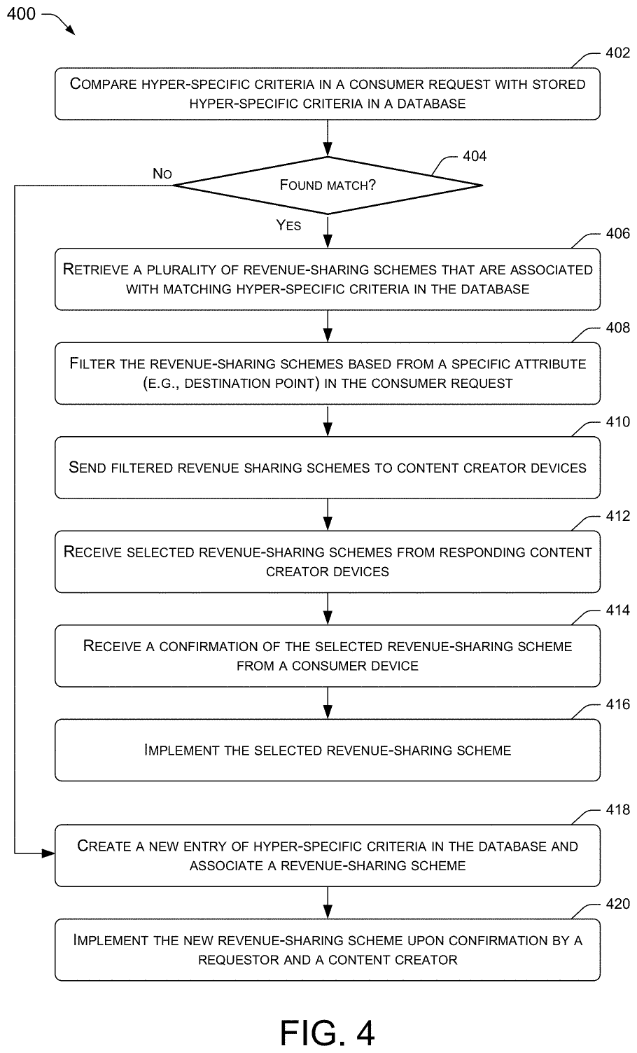

FIG. 4 is a flow diagram 400 that depicts a methodological implementation of at least one aspect of the techniques for establishing revenue-sharing schemes between the requestor and the content creator. In the following discussion of FIG. 4, continuing reference is made to the elements and reference numerals shown in and described with respect to the network server environment 200 and content sharing services server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 402, the revenue controller 264 compares hyper-specific criteria in a consumer request with stored hyper-specific media in a database. In one example, a user enters hyper-specific criteria in a consumer request (hyper-specific criteria 116 in FIG. 1) to view a hyper-specific media content. In this example, the revenue controller 264 may compare the user entered hyper-specific criteria with a list of stored hyper-specific criteria in the hyper-specific criteria module 272.

At decision block 404, the revenue controller 264 determines whether a match is found. If a match is found (“Yes” at block 404), then at block 406, the revenue controller 264 may retrieve revenue-sharing schemes that are associated with the matching hyper-specific criteria. For example, the first hyper-specific criteria 310-2 is found to match the hyper-specific criteria 116 in the consumer request 112. In this example, the revenue-sharing schemes 300(2)-300(8) may include the revenue-sharing schemes that are associated with the matching first hyper-specific criteria 310-2.

At block 408, the revenue controller 264 filters the initially retrieved plurality of revenue-sharing schemes based upon a specific revenue-sharing scheme attribute in the consumer request. In one example, the requestor may include a specific attribute in the consumer request. The specific attribute can be a destination point 320 such as, for example, a YouTube™ channel. In this case, the revenue controller 264 may filter the initially retrieved plurality of revenue-sharing schemes 300(2)-300(8) by selecting only the revenue-sharing schemes 300(2)-300(4) that are associated with YouTube™ 320(2) and YouTube™ 320(4), respectively.

At block 410, the revenue controller 264 sends filtered revenue-sharing schemes to content creator devices. In one example, the content creator devices that receive the revenue-sharing schemes may be identified based upon authoring qualifications that can be associated with the consumer request. The authoring qualifications may include criteria for the selection of at least one content creator device that may capture the hyper-specific media content. For example, the authoring qualifications may include the selection of one or more content creator devices based upon their association with the matching hyper-specific criteria in the database; their proximity (e.g., within a predetermined distance) from a specific location of a specific subject; and/or c) their associated user ratings, client profile, good credit history, etc. In this example, the revenue controller 264 sends filtered revenue-sharing schemes to the selected content creator devices.

At block 412, the revenue controller 264 receives selected revenue-sharing schemes from responding content creator devices. Continuing with the example above, where the revenue-sharing schemes 300(2)-300(4) are sent to the content creator device, the receiving content creator devices may select one of the revenue-sharing schemes 300(2)-300(4). In this example, the revenue controller 264 receives the selected revenue-sharing schemes from the responding content creator devices. The revenue controller 264 may then forward the selected revenue-sharing schemes to the requestor consumer device.

At block 414, the revenue controller 264 receives a confirmation of the selected revenue-sharing scheme from the consumer device. The received confirmation may indicate the revenue-sharing scheme that has been agreed upon by the parties. Thereafter, at block 416, the content crowdsourcing app 260 implements the selected revenue-sharing scheme. For example, the content crowdsourcing app 260 facilitates the transmission of the requested hyper-specific media content to the destination points (e.g., social network platforms 230). In this example, the content crowdsourcing app 260 may use the selected revenue-sharing scheme attributes as a reference for the monetization of the hyper-specific media content. The monetization may include charging of service fees, payment of requestor sales percentages, etc.

Returning to decision block 404, when no match is found (“No” at block 404), the process continues at block 418 where the revenue controller 264 creates a new entry of hyper-specific criteria in the hyper-specific criteria module 274. Further, the revenue controller 264 may be configured to associate a new revenue-sharing scheme to the created hyper-specific criteria. The new revenue-sharing scheme may include default attributes such as the amount of service fees, triggering thresholds, sales percentage for the consumer device, etc. At block 420, the revenue controller 264 implements the initial revenue-sharing scheme upon confirmation by the content creator device and the requestor consumer device.

### Example Implementation—Filtering and Implementing Revenue-Sharing Schemes

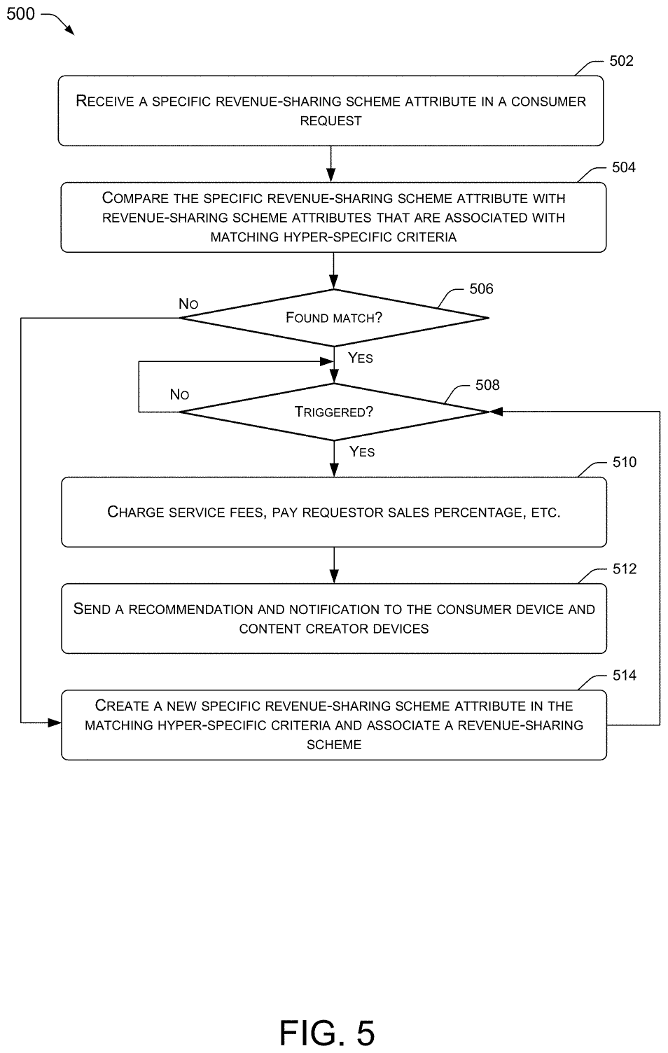

FIG. 5 is a flow diagram 500 that depicts a methodological implementation of at least one aspect of the techniques for filtering and implementing the selected revenue-sharing scheme between the requestor and the content creator. In the following discussion of FIG. 5, continuing reference is made to the elements and reference numerals shown in and described with respect to the network server environment 200 and content sharing services server 202 of FIG. 2. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 502, the content crowdsourcing app 260 receives a specific revenue-sharing scheme attribute in the consumer request. For example, the specific attribute may include specific information such as destination points, cancellation policy, etc. in the pre-configured revenue-sharing schemes 300.

At block 504, the revenue controller 264 compares the received specific revenue-sharing scheme attribute with revenue-sharing scheme attributes that are associated with the matching hyper-specific criteria. When a matching attribute is found (“Yes” at decision block 506), the revenue controller 264 determines whether the triggering threshold attribute of the revenue-sharing scheme that is associated with the matching attribute has been satisfied. When the triggering threshold has been satisfied (“Yes” at decision block 508), then the revenue controller 264 initiates, for example, the charging of service fees 330, requestor sales percentage 350, and creator sales percentage 360. Further, the revenue controller 264 may send recommendation such as the trending level recommendation 380 and other notifications to the requestor and the content creator.

Returning to decision block 506, when no matching attribute is found (“No” at block 506), the revenue controller 264 in communication with the revenue-sharing scheme module 274 may create a new specific attribute in addition to other revenue-sharing scheme attributes that are utilized in the LUT. The process may then proceed to decision block 508 to determine whether the triggering threshold has been satisfied. If the triggering threshold is satisfied (“Yes” at block 508), then the process continues at block 510 for the charging of service fees, pay sales percentage, etc. If the triggering threshold is not satisfied (“No” at block 508), then the process of determining the satisfaction of the triggering threshold is repeated.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. One or more computer-readable storage media collectively storing computer-executable instructions that upon execution collectively cause one or more computers to perform acts comprising:
receiving, from a first device, media content criteria of a media content for a particular event;
comparing the media content criteria with a list of stored media content criteria in a database;
selecting a revenue-sharing scheme from a plurality of revenue-sharing schemes that are associated with matching media content criteria, wherein a selected revenue-sharing scheme includes revenue-sharing scheme attributes that outline a compensation for a consumption of the media content that is transmitted by a second device;
using the selected revenue-sharing scheme to compensate the first device and the second device.

2. The one or more computer-readable storage media of claim 1 further comprising: receiving a specific revenue-sharing scheme attribute from the first device; using the specific revenue-sharing scheme attribute to filter the plurality of revenue-sharing schemes that are associated with the matching media content criteria; and sending filtered revenue-sharing schemes to the second device.

3. The one or more computer-readable storage media of claim 2, wherein the selected revenue-sharing scheme includes the revenue-sharing scheme that is selected by the second device from the filtered revenue-sharing schemes and confirmed for use by the first device.

4. The one or more computer-readable storage media of claim 1, wherein the revenue-sharing scheme attributes include a triggering threshold that is used as a reference to charge service fees from the first device.

5. The one or more computer-readable storage media of claim 1, wherein the revenue-sharing scheme attributes include a triggering threshold that is based on a number of media content downloads at a destination point.

6. The one or more computer-readable storage media of claim 1, wherein the revenue-sharing scheme attributes include a triggering threshold that is based on a lapse of a waiting time period.

7. The one or more computer-readable storage media of claim 1, wherein the revenue-sharing scheme attributes include a cancellation policy.

8. The one or more computer-readable storage media of claim 1, wherein the media criteria include a specific subject, location, and time condition.

9. The one or more computer-readable storage media of claim 1, wherein the plurality of revenue-sharing schemes are stored in a look-up table (LUT) in the database.

10. A device, comprising:
a processor;
a memory coupled to the processor, the memory further comprises:
a consumer request module configured to receive, from a consumer device, media content criteria of a media content for a particular event;
a revenue controller configured to: compare the media content criteria with a list of stored media content criteria in a database; select a revenue-sharing scheme from a plurality of revenue-sharing schemes that are associated with matching media content criteria, wherein a selected revenue-sharing scheme includes revenue-sharing scheme attributes that outline a compensation for a consumption of the media content that is transmitted by a content creator device, and; facilitate payments to the consumer device and content creator device based on the selected revenue-sharing scheme.

11. The device of claim 10, wherein the revenue controller further receives a specific revenue-sharing scheme attribute from the consumer device; utilizes the specific revenue-sharing scheme attribute to filter the plurality of revenue-sharing schemes that are associated with the matching media content criteria; and sends filtered revenue-sharing schemes to the content creator device

12. The device of claim 11, wherein the selected revenue-sharing scheme includes the revenue-sharing scheme that is selected by the content creator device from the filtered revenue-sharing schemes and confirmed for use by the consumer device.

13. The device of claim 11, wherein the specific revenue-sharing scheme attribute includes a destination point.

14. The device of claim 10, wherein the revenue-sharing scheme attributes include a triggering threshold that the revenue controller utilizes as a reference to charge service fees from the consumer device.

15. The device of claim 10, wherein the revenue-sharing scheme attributes include a triggering threshold that is based on a number of media content downloads at a destination point.

16. The device of claim 10, wherein the revenue-sharing scheme attributes include a triggering threshold that is based on a lapse of a waiting time period.

17. The device of claim 10, wherein the revenue-sharing schemes are stored in a look-up table (LUT) in the database.

18. A computer-implemented method, comprising:
receiving, from a first device, media content criteria of a media content for a particular event and a destination point;
comparing the media content criteria with a list of stored media content criteria in a database;
filtering a plurality of revenue-sharing schemes that are associated with matching media content criteria based on the destination point;
selecting a revenue-sharing scheme from filtered of revenue-sharing schemes, wherein a selected revenue-sharing scheme includes revenue-sharing scheme attributes that outline a compensation for a consumption of the media content that is transmitted by a second device; and
using the selected revenue-sharing scheme to compensate the first device and the second device.

19. The computer-implemented method of claim 18, wherein the revenue-sharing scheme attributes include a triggering threshold that is used as a reference to charge service fees from the first device.

20. The computer-implemented method of claim 18, wherein the revenue-sharing schemes are stored in a look-up table (LUT) in the database.
